(19) United States
(12) Patent Application Publication
(10) Pub. No.: US 2025/0076507 A1
(43) Pub. Date: Mar. 6, 2025

(54) OPTICAL DISPLACEMENT METER

(71) Applicant: Keyence Corporation, Osaka (JP)

(72) Inventor: Izumi MORI, Osaka (JP)

(73) Assignee: Keyence Corporation, Osaka (JP)

(21) Appl. No.: 18/780,619

(22) Filed: Jul. 23, 2024

(30) Foreign Application Priority Data
Aug. 30, 2023 (JP) 2023-139462

(51) Int. Cl. G01S 17/89; F16C 33/66; G01B 11/24; G01S 7/481

(52) U.S. Cl. CPC G01S 17/89; F16C 33/6681; G01B 11/24; G01S 7/4817

(57) ABSTRACT

An influence of fretting wear is suppressed. An optical displacement meter includes: a light projecting/receiving module including a light projecting unit that emits slit light extending in an X direction, a light receiving lens that collects reflected light from a workpiece, and an imaging unit that receives light collected by the light receiving lens; a motor integrally rotating the light projecting/receiving module; a bearing supporting a rotation shaft of the light projecting/receiving module; and a control unit controlling the motor to rotate the light projecting/receiving module within a first angle range to be measured to scan the slit light in a direction orthogonal to the X direction. The bearing is rotated together with the light projecting/receiving module by the rotation of the motor to a second angle range not to be measured on the outer side of the first angle range.

### CROSS-REFERENCE TO RELATED APPLICATIONS

The present application claims foreign priority based on Japanese Patent Application No. 2023-139462, filed Aug. 30, 2023, the contents of which are incorporated herein by reference.

### BACKGROUND OF THE INVENTION

### 1. Technical Field

The invention relates to an optical displacement meter.

### 2. Description of the Related Art

In a case where a conventional optical displacement meter acquires XZ cross-sectional profiles at different positions in a Y direction of a measurement object (workpiece) and generates three-dimensional shape data from these profiles, equipment such as a conveyor for conveying the workpiece and a linear motion mechanism for moving a main body of the conventional optical displacement meter with respect to the workpiece is required.

However, installation space, cost, and the like may hinder introduction of the above-described equipment.

Meanwhile, as an optical displacement meter capable of acquiring XZ cross-sectional profiles of a workpiece at different positions in a Y direction and generating three-dimensional shape data from these profiles without requiring the above-described equipment, an optical displacement meter that rotates a light projecting system and a light receiving system is known (see European Patent Application Publication No. 3232152 and Chinese Utility Model No. 210664364).

In the optical displacement meter that rotates the light projecting system and the light receiving system, it is assumed that a bearing that rotatably supports a rotor of a motor is provided in order to achieve smooth and stable rotation when the light projecting system and the light receiving system are rotationally driven by the motor. When the rotor of the motor is reciprocated (swung) within a predetermined rotation angle range, fretting wear occurs depending on the rotation angle range.

However, no countermeasure is taken against the fretting wear in European Patent Application Publication No. 3232152 and Chinese Utility Model No. 210664364.

### SUMMARY OF THE INVENTION

In view of the above problems, an object of the invention is to provide an optical displacement meter capable of suppressing an influence of fretting wear.

According to one embodiment of the invention, for example, an optical displacement meter includes: a light projecting/receiving module including a light projecting unit that emits slit light extending in an X direction, a light receiving lens that collects reflected light from a workpiece, and an imaging unit that receives light collected by the light receiving lens; a motor that integrally rotates the light projecting/receiving module; a bearing that supports a rotation shaft of the light projecting/receiving module; and a control unit that controls the motor to rotate the light projecting/receiving module in a first angle range to be measured to scan the slit light in a direction orthogonal to the X direction, in which the bearing is rotated together with the light projecting/receiving module by the motor to a second angle range not to be measured on the outer side of the first angle range.

According to another embodiment of the invention, for example, an optical displacement meter includes: a light projecting/receiving module including a light projecting unit that emits slit light extending in an X direction, a light receiving lens that collects reflected light from a workpiece, and an imaging unit that receives light collected by the light receiving lens; a motor that integrally rotates the light projecting/receiving module; a bearing that support a rotation shaft of the light projecting/receiving module; and a control unit that controls the motor to rotate the light projecting/receiving module in a first angle range to be measured to scan the slit light in a direction orthogonal to the X direction, in which the bearing includes an inner ring, an outer ring, a plurality of rolling elements disposed movably between the inner ring and the outer ring, and a lubricant covering the plurality of rolling elements, the plurality of rolling elements move between the inner ring and the outer ring as the light projecting/receiving module rotates, and the lubricant enters between the inner ring and the rolling elements and between the outer ring and the rolling elements due to the movement of the plurality of rolling elements when the light projecting/receiving module rotates from one end to the other end of the first angle range.

Note that other features, elements, steps, advantages, and characteristics will be more apparent from the following detailed description of preferred embodiments and the accompanying drawings.

According to the invention, it is possible to provide the optical displacement meter capable of suppressing the influence of fretting wear.

### BRIEF DESCRIPTION OF THE DRAWINGS

FIG. 1 is a diagram illustrating an optical displacement measurement system;

FIG. 2 is a view illustrating the principle of triangulation;

FIG. 3 is a view illustrating an optical displacement meter including a reflecting member;

FIG. 4 is a view illustrating a method of detecting a peak position;

FIG. 5 is a functional block diagram of the optical displacement meter;

FIG. 6 is a view illustrating a first example of a layout of a motor;

FIG. 7 is a view illustrating the first example of the layout of the motor;

FIG. 8 is a view illustrating a second example of the layout of the motor;

FIG. 9 is a view illustrating the second example of the layout of the motor;

FIG. 10 is a view illustrating a processing flow of a measurement operation of the optical displacement measurement system;

FIG. 11A is a view illustrating an angle range of a light projecting/receiving module;

FIG. 11B is a view illustrating an angle range of a light projecting/receiving module;

FIG. 12A is a view illustrating an angle range of the light projecting/receiving module;

FIG. 12B is a view illustrating an angle range of the light projecting/receiving module;

FIG. 13A is a view illustrating an angle range of the light projecting/receiving module;

FIG. 13B is a view illustrating an angle range of the light projecting/receiving module;

FIG. 14 is a view illustrating a schematic configuration example of a bearing; and

FIG. 15 is a view illustrating a processing flow of a maintenance operation of the optical displacement measurement system.

### DETAILED DESCRIPTION

### <Optical Displacement Measurement System>

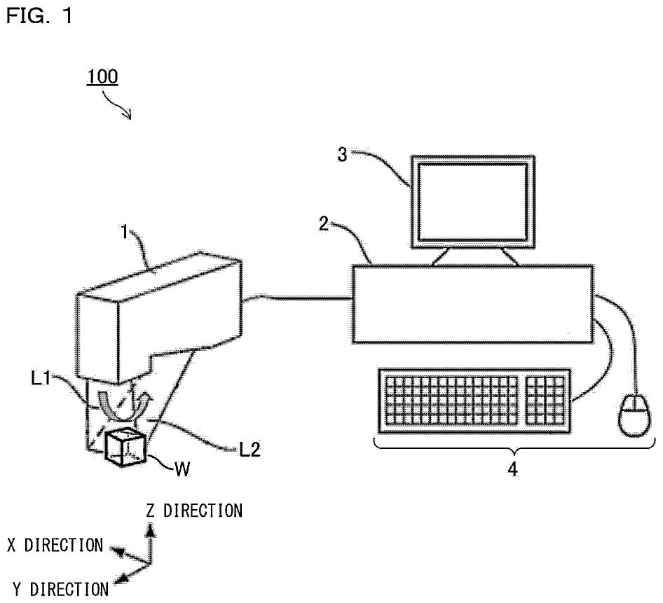

FIG. 1 is a diagram illustrating a schematic configuration example of an optical displacement measurement system. An optical displacement measurement system 100 of the present configuration example includes an optical displacement meter 1, a control device 2, a display device 3, and an input device 4.

In the present configuration example, an X direction corresponds to a width direction of slit light L1 output from the optical displacement meter 1, a Z direction corresponds to a height direction of a workpiece W, and a Y direction corresponds to a direction in which the slit light L1 moves by rotation of a light projecting unit (not illustrated in FIG. 1). A XZ plane to be described later is a plane extending in the X direction and the Z direction. Note that the optical displacement meter 1 scans the slit light L1 by rotating a light projecting/receiving module 20, and thus, a scanning direction of the slit light L1 is a direction orthogonal to the X direction on a YZ plane including the Y direction. Note that “rotation” in the present specification means swinging motion that reciprocates with a rotation axis as the center.

The optical displacement measurement system 100 is a system that measures a profile and a three-dimensional shape of the workpiece W. The profile of the workpiece W is data indicating an outer edge of a cut surface of the workpiece W by the slit light L1. When the slit light is emitted in parallel to the XZ plane, the profile of the workpiece W is data indicating an outer edge of a cut surface parallel to the XZ plane, and thus, is also referred to as a two-dimensional profile of a XZ cross-section of the workpiece W.

For example, the profile is an aggregate of (xi, zi) (i is an index). “xi” indicates a position in the X direction. “zi” indicates a height in the Z direction. Note that the three-dimensional shape is an aggregate of (xi, yi, zi). “yi” indicates a position in the Y direction.

The optical displacement meter 1 operates in accordance with an instruction from the control device 2. The optical displacement meter 1 outputs the slit light L1 extending in the X direction and receives reflected light L2 from the workpiece W. Then, the optical displacement meter 1 calculates a profile of the workpiece W based on a light receiving result. The optical displacement meter 1 captures images at regular intervals to generate profiles of the workpiece W having different values of yi. In addition, the optical displacement meter 1 generates three-dimensional shape data of the workpiece W from the profiles of the workpiece W having different values of yi.

The control device 2 outputs an instruction based on a user input received by the input device 4 to the optical displacement meter 1, and receives a measurement result of the workpiece W from the optical displacement meter 1. In addition, the control device 2 outputs a display signal to the display device 3. The control device 2 is, for example, a personal computer, a programmable logic control unit, or the like.

The display device 3 displays, for example, the measurement result of the workpiece W, a user interface (UI) for setting the optical displacement meter 1, and the like based on the display signal from the control device 2.

The input device 4 receives the user input with respect to the optical displacement measurement system 100. In FIG. 1, a keyboard and a mouse are illustrated as the input device 4. However, the input device 4 is not limited to the keyboard and the mouse. For example, the input device 4 may be a touch panel disposed on a display screen of the display device 3.

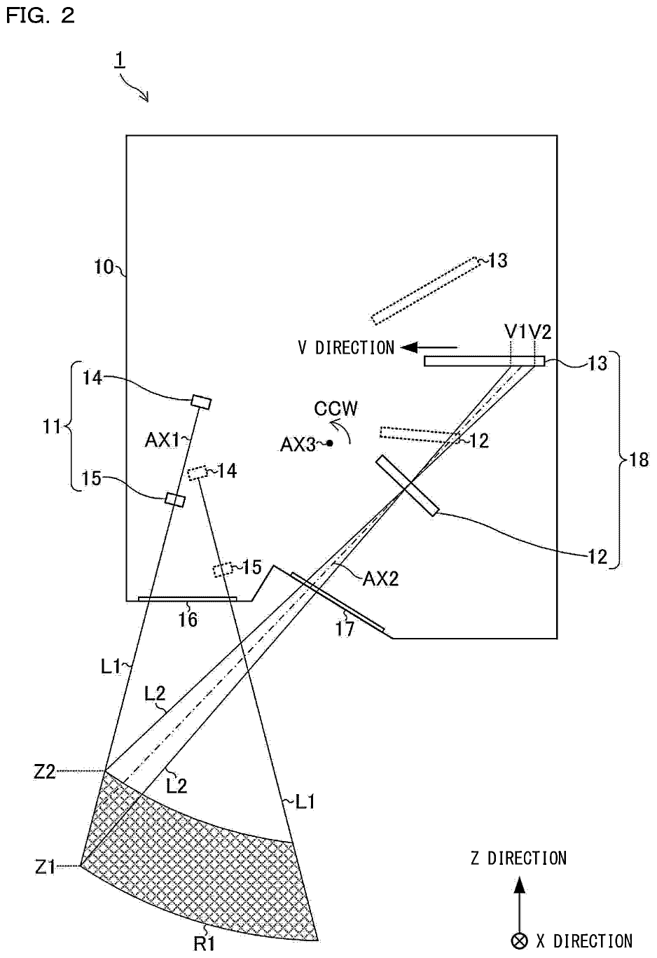

FIG. 2 is a view for describing the principle of a light sectioning method (triangulation). A light projecting unit 11, a light receiving lens 12, and an imaging unit 13 are stored in a housing 10 of the optical displacement meter 1. The light projecting unit 11 includes a light source 14 and a light projecting lens 15. For example, the light source 14 may be a laser light emitter, and the light projecting lens 15 may include a plurality of lenses including a cylindrical lens.

Light output from the light source 14 passes through the light projecting lens 15 and is converted into the slit light L1. The housing 10 is provided with a light projecting window 16 having a light transmitting property that allows the slit light L1 to pass therethrough. Similarly, the housing 10 is provided with a light receiving window 17 having a light transmitting property that allows the reflected light L2 to pass therethrough.

The light receiving lens 12 is a lens configured to collect the reflected light L2 and form an image on a light receiving surface of the imaging unit 13. The light receiving lens 12 may include only one lens or may include a plurality of lenses. In addition, the light receiving lens 12 may also include an optical component (for example, an optical filter or the like) other than the lens. The imaging unit 13 is an image sensor including a plurality of photoelectric conversion elements arranged two-dimensionally. The imaging unit 13 receives the light collected by the light receiving lens.

As illustrated in FIG. 2, an optical axis AX2 of the light receiving lens 12 is inclined with respect to a light projection axis AX1 of the light projecting unit 11. The light projection axis AX1 of the light projecting unit 11 coincides with an optical axis of the light source 14. As a result, the reflected light L2 from a height Z1 forms an image at a position V1 in a V direction of the light receiving surface of the imaging unit 13, and the reflected light L2 from a height Z2 forms an image at a position V2 in the V direction of the light receiving surface of the imaging unit 13. That is, the V direction of the light receiving surface of the imaging unit 13 corresponds to the Z direction of the workpiece W. Although a U direction of the light receiving surface of the imaging unit 13 is not illustrated, the U direction corresponds to the X direction of the workpiece W. That is, a vertical direction of an image, which is a light receiving result output by the imaging unit 13, is the V direction, and a horizontal direction thereof is the U direction.

The light projecting unit 11, the light receiving lens 12, and the imaging unit 13 are rotatable about a rotation axis AX3 along the X direction in a state of satisfying the Scheimpflug relationship in which the light receiving surface of the imaging unit 13 is inclined with respect to the optical axis of the light receiving lens 12. Relative positions of the light projecting unit 11, the light receiving lens 12, and the imaging unit 13 are fixed. In FIG. 2, a state of the light projecting unit 11, the light receiving lens 12, and the imaging unit 13 before rotation in a counterclockwise direction CCW is illustrated by a solid line, and a state thereof after rotation in the counterclockwise direction CCW is illustrated by a broken line.

The light projecting unit 11, the light receiving lens 12, and the imaging unit 13 are rotatable about the rotation axis AX3 along the X direction in the state of satisfying the Scheimpflug relationship. As a result, each cross-section through which the light projection axis AX1 passes is in focus in a region RI illustrated by hatching in FIG. 2. That is, the optical displacement meter 1 can generate the profile of the workpiece W in focus even if the height of the workpiece W changes.

Note that the positional relationship among the light projecting unit 11, the light receiving lens 12, and the imaging unit 13 may be opposite to the positional relationship illustrated in FIG. 2.

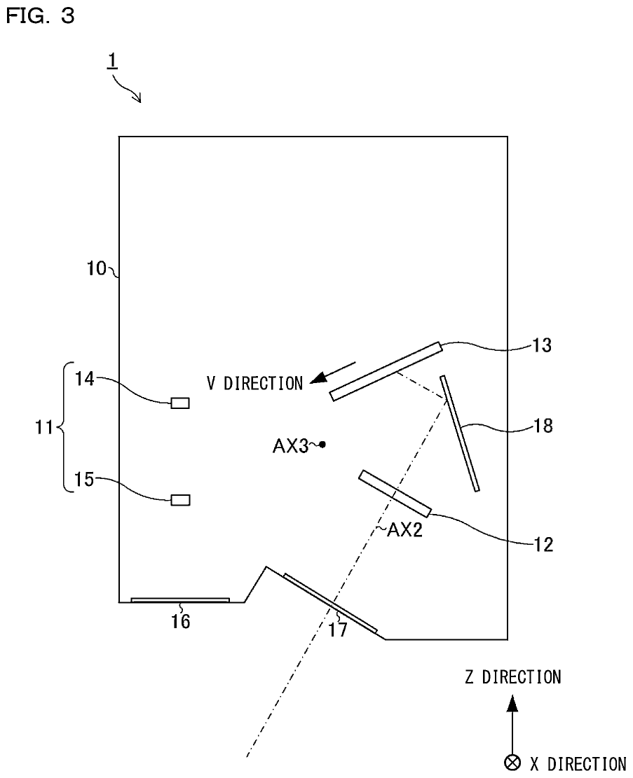

In addition, the optical displacement meter 1 may further include a reflecting member 18 as illustrated in FIG. 3. The reflecting member 18 is provided on an optical path between the light receiving window 17 and the imaging unit 13, and turns the reflected light L2 and the optical axis AX2 of the light receiving lens 12 toward the light projecting unit 11. As a result, it is possible to form a compact light projecting/receiving module that integrally holds the light projecting unit 11, the light receiving lens 12, the imaging unit 13, and the reflecting member 18 in the YZ plane extending in the Y direction and the Z direction. Therefore, it is possible to reduce a moment of inertia about the rotation axis AX3 of the light projecting/receiving module integrally holding the light projecting unit 11, the light receiving lens 12, the imaging unit 13, and the reflecting member 18.

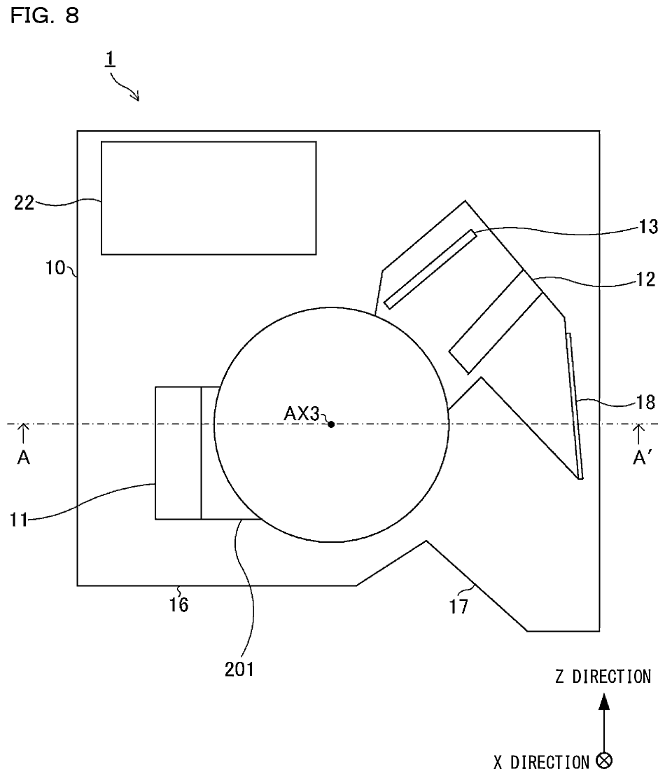

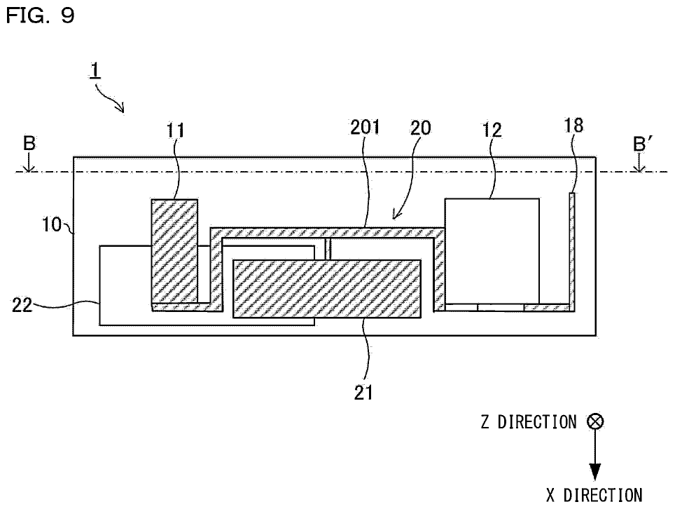

In FIG. 3, the reflecting member 18 is provided on the optical path between the light receiving lens 12 and the imaging unit 13, but may be provided on an optical path between the light receiving window 17 and the light receiving lens 12 (for example, see FIGS. 8 and 9 to be described later).

In a case where the reflecting member 18 is provided on the optical path between the light receiving lens 12 and the imaging unit 13, the reflecting member 18 reflects the light collected by the light receiving lens 12, and thus, the area of a reflection surface of the reflecting member 18 can be reduced. In a case where the reflecting member 18 is provided on the optical path between the light receiving window 17 and the light receiving lens 12, the heavy light receiving lens 12 can be disposed close to the rotation axis AX3, and thus, the effect of reducing the moment of inertia increases.

### <Position (Calculation of Height)>

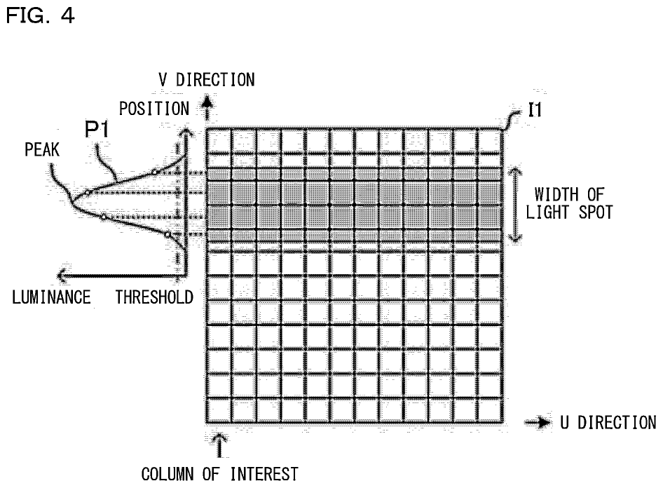

FIG. 4 is a view for describing a method of calculating a height forming a profile from an image I1 that is a light receiving result output by the imaging unit 13. The slit light L1 has a certain width in the Y direction. Therefore, a width of a light spot formed by the reflected light L2 on the light receiving surface of the imaging unit 13 is also a width that spans the plurality of photoelectric conversion elements.

Therefore, the optical displacement meter 1 obtains an approximate curve P1 indicating a change in a luminance value from luminance values of pixels, and calculates a position in the V direction at which a peak value is obtained in the approximate curve P1. In FIG. 4, the leftmost column is a column of interest, and the distribution (approximate curve P1) of luminance values of the column of interest is illustrated. The approximate curve P1 is obtained by curve fitting or the like of a plurality of sample values. A sample value below a detection threshold is not considered. The position in the V direction at which the peak value is obtained indicates a height of the workpiece W. The optical displacement meter 1 obtains the approximate curve P1 at each position (each pixel column) in the U direction, and calculates the position (height) in the V direction at which the peak value is obtained from the approximate curve P1. This calculation processing is executed at each position in the U direction, thereby obtaining one profile. Such calculation processing may be referred to as subpixel processing.

Note that, for example, a coordinate conversion condition (for example, a coordinate conversion table) indicating a correspondence relationship among UV coordinates, a rotation angle θ, and local coordinates (X, Y, Z) and expressed by (U, V, θ)=(X, Y, Z) is generated by calibration before shipment, and is stored in a storage unit (not illustrated) of the optical displacement meter 1, and thus, the optical displacement meter 1 can convert coordinates of a profile in a UV coordinate system into coordinates in an XYZ coordinate system based on the rotation angle θ by simple calculation.

### <Functional Blocks>

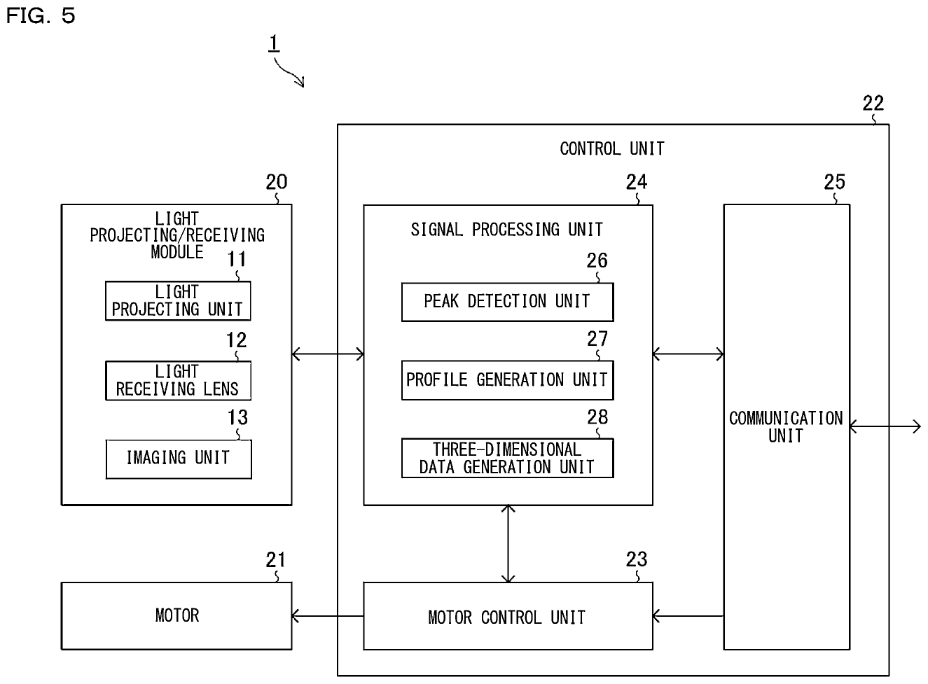

FIG. 5 is a functional block diagram of the optical displacement meter 1. The optical displacement meter 1 includes the light projecting/receiving module 20, a motor 21, and a control unit 22.

The light projecting/receiving module 20 holds the light projecting unit 11, the light receiving lens 12, and the imaging unit 13 in an integrated manner. In addition, in a case where the optical displacement meter 1 includes the reflecting member 18, the light projecting/receiving module 20 holds the light projecting unit 11, the light receiving lens 12, the imaging unit 13, and the reflecting member 18 (not illustrated in FIG. 5) in an integrated manner.

The motor 21 rotates the light projecting unit 11, the light receiving lens 12, and the imaging unit 13. More specifically, the motor 21 rotates the light projecting/receiving module 20. The motor 21 may rotate the light projecting/receiving module 20 by a direct drive system in which an intermediate mechanism such as a speed reducer is not disposed between the motor 21 and the light projecting/receiving module 20, or may rotate the light projecting/receiving module 20 via the intermediate mechanism such as the speed reducer.

The control unit 22 includes a motor control unit 23, a signal processing unit 24, and a communication unit 25. The control unit 22 controls the motor 21 to rotate the light projecting unit 11, the light receiving lens 12, and the imaging unit 13 in the state of satisfying the Scheimpflug relationship, and scans the slit light L1 in a direction orthogonal to the X direction. More specifically, the motor control unit 23 controls the motor 21 to rotate the light projecting unit 11, the light receiving lens 12, and the imaging unit 13 in the state of satisfying the Scheimpflug relationship, and the signal processing unit 24 controls the light projecting unit 11 to emit the slit light L1 from the light projecting unit 11.

The signal processing unit 24 includes a peak detection unit 26, a profile generation unit 27, and a three-dimensional data generation unit 28. The peak detection unit 26 detects positions (peak positions) in the V direction having peaks of luminance values based on light receiving results output from the imaging unit 13. The profile generation unit 27 generates one piece of profile data by collecting heights (zi) of the workpieces W at the respective positions (xi) in the X direction obtained by the peak detection unit 26. The three-dimensional data generation unit 28 generates three-dimensional shape data of the workpiece W from profiles of the workpieces W having different values of yi and generated by the profile generation unit 27. Note that at least a part of the peak detection unit 26, the profile generation unit 27, and the three-dimensional data generation unit 28 may be provided inside not the optical displacement meter 1 but the control device 2 (see FIG. 1).

The communication unit 25 performs wired or wireless communication with the control device 2. For example, the communication unit 25 receives an instruction from the control device 2 and transmits the instruction to the control unit 22. In addition, the communication unit 25 transmits, for example, the profile data and the three-dimensional shape data of the workpiece W generated by the signal processing unit 24 to the control device 2.

### <Layout of Motor>

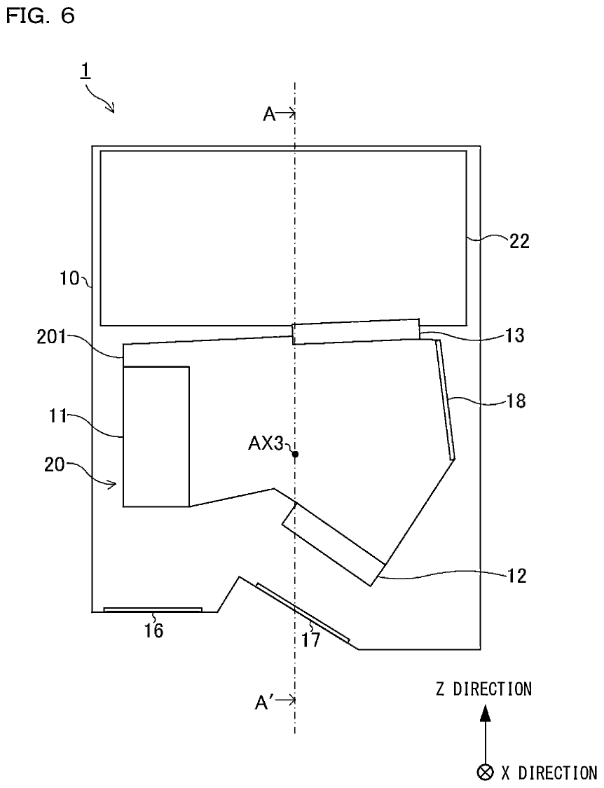

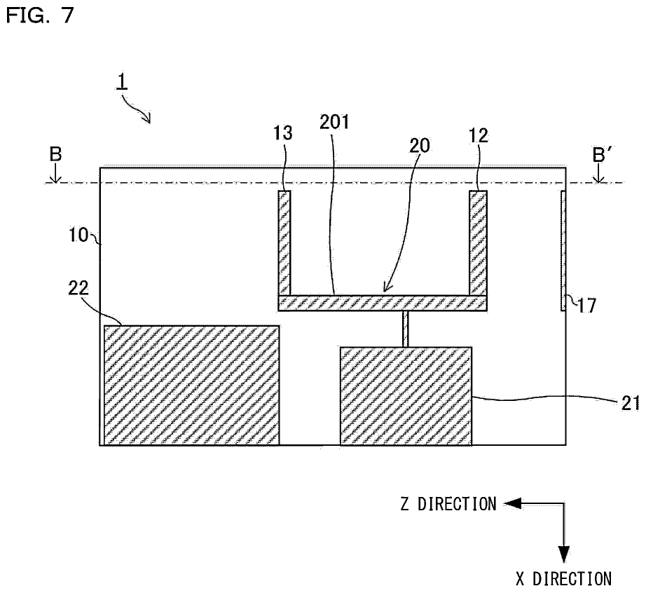

FIGS. 6 and 7 are views illustrating a first example of a layout of the motor 21. FIG. 6 is a cross-sectional view perpendicular to the X direction of the optical displacement meter 1 taken along line B-B′ in FIG. 7. FIG. 7 is a cross-sectional view along the XZ plane of the optical displacement meter 1 taken along line A-A′ in FIG. 6.

In the first example, the light projecting/receiving module 20 includes a plate-shaped base member 201 extending along a plane perpendicular to the X direction. The light projecting unit 11, the light receiving lens 12, the imaging unit 13, and the reflecting member 18 are mounted on the base member 201.

In the first example, the light projecting/receiving module 20 does not overlap the motor 21 and an accessory component of the motor 21 in the X direction. The accessory component of the motor 21 is, for example, an encoder that detects a rotation amount of a rotor of the motor 21. According to the first example of the layout of the motor 21, it is easy to dispose the light projecting unit 11 close to the light receiving lens 12, and the imaging unit 13. The light projecting/receiving module 20 can be made compact by bringing the light projecting unit 11 close to the light receiving lens 12 and the imaging unit 13. Therefore, the moment of inertia about the rotation axis AX3 of the light projecting/receiving module 20 can be reduced.

In addition, in the first example, the control unit 22 does not overlap the light projecting/receiving module 20 in the X direction but overlaps the motor 21 in the X direction.

FIGS. 8 and 9 are views illustrating a second example of the layout of the motor 21. FIG. 8 is a cross-sectional view perpendicular to the X direction of the optical displacement meter 1 taken along line B-B′ in FIG. 9. FIG. 9 is a cross-sectional view perpendicular to the Z direction of the optical displacement meter 1 taken along line A-A′ in FIG. 8.

In the second example, the light projecting/receiving module 20 includes the base member 201. The base member 201 includes a tubular portion extending along the X direction, a lid portion closing one end of the tubular portion in the X direction, and a flange portion extending radially outward from the other end of the tubular portion in the X direction. The light projecting unit 11, the light receiving lens 12, the imaging unit 13, and the reflecting member 18 are mounted on the flange portion of the base member 201.

In the second example, the light projecting/receiving module 20 overlaps at least one of the motor 21 and an accessory component of the motor 21 in the X direction. The accessory component of the motor 21 is, for example, an encoder that detects a rotation amount of a rotor of the motor 21, which is similar to the first example. According to the second example of the layout of the motor 21, it is easy to dispose the light projecting unit 11 away from the light receiving lens 12, and the imaging unit 13. Since the light projecting unit 11 is disposed away from the light receiving lens 12 and the imaging unit 13, scanning range of the slit light L1 can be expanded.

In addition, in the second example, the control unit 22 overlaps the light projecting/receiving module 20 and the motor 21 in the X direction. Note that the control unit 22 may be disposed at a position not overlapping the motor 21 in the X direction but overlapping the motor 21 as viewed from the X direction. In a case where the control unit 22 is disposed at the position overlapping the motor 21 as viewed from the X direction without overlapping the motor 21 in the X direction, the control unit 22 may overlap or does not necessarily overlap the light projecting/receiving module 20 and the motor 21 in the X direction.

### <Processing Flow (Measurement Operation)>

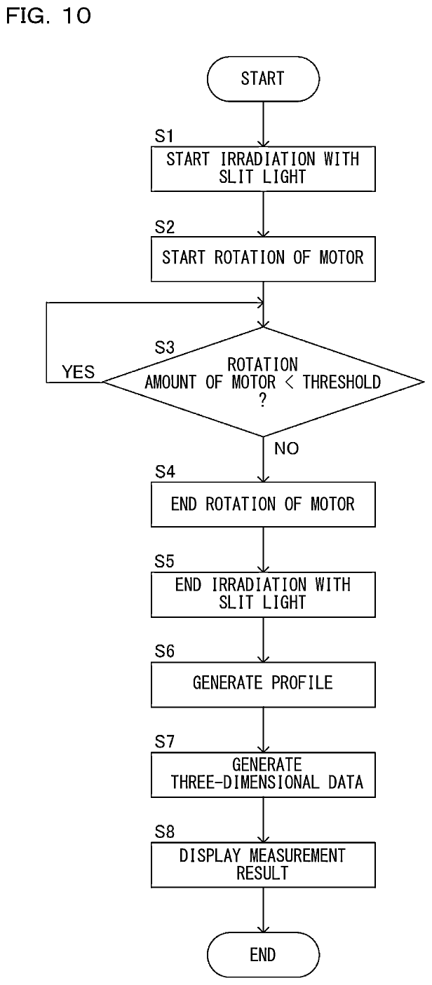

FIG. 10 is a view illustrating a processing flow of a measurement operation of the optical displacement measurement system 100. When the input device 4 receives a user input for instructing start of measurement, the processing flow of FIG. 10 is started. When the optical displacement measurement system 100 executes the measurement operation, the optical displacement meter 1 executes a measurement operation.

First, in step S1, the light projecting unit 11 starts irradiation with the slit light L1. In subsequent step S2, the motor control unit 23 starts rotation of the motor 21. Note that the process of step S1 and the process of step S2 may be executed simultaneously. Before execution of step S1, the motor control unit 23 may rotate the motor in order to move the light projecting/receiving module 20 to a predetermined scanning start position. By the processes of steps S1 and S2, scanning of the slit light L1 is started.

In subsequent step S3, the motor control unit 23 determines whether or not a rotation amount (rotation angle) of the motor 21 from the start of rotation is smaller than a threshold. In a case where the rotation amount of the motor 21 from the start of rotation is smaller than the threshold, the determination process of step S3 is continued, and the scanning of the slit light L1 is continued.

When the rotation amount of the motor 21 from the start of rotation reaches the threshold, the flow proceeds to step S4. Note that the threshold is a rotation amount calculated based on a measurement range. The measurement range is set by default, and when the user changes the measurement range, the control unit 22 (for example, the signal processing unit 24) calculates a threshold of a rotation amount based on the changed measurement range.

In step S4, the motor control unit 23 ends the rotation of the motor 21. In subsequent step S5, the light projecting unit 11 ends the irradiation with the slit light L1. Note that the process of step S4 and the process of step S5 may be executed simultaneously. By the processes of steps S4 and S5, the scanning of the slit light L1 is ended.

In subsequent step S6, the profile generation unit 27 generates a profile. Note that the profile generation unit 27 may start to generate a profile during the scanning with the slit light L1.

In subsequent step S7, the three-dimensional data generation unit 28 generates three-dimensional data.

In subsequent step S8, the display device 3 displays a measurement result. The measurement result is, for example, a cross-sectional view of the workpiece W based on the profile, a three-dimensional image of the workpiece W based on three-dimensional data, or the like. When the process of step S8 ends, the processing flow of FIG. 10 ends.

The optical displacement meter 1 has a measurement period in which the light projecting/receiving module 20 is rotated at a substantially constant speed in a first rotation direction (the counterclockwise direction CCW) or a second rotation direction (a clockwise direction CW) and a measurement operation is executed, and a non-measurement period in which the measurement operation is not executed. In the measurement period in which the measurement operation is executed, the motor rotates the light projecting/receiving module 20 at the substantially constant speed. The non-measurement period includes at least an activation period from activation to a first measurement operation, a period for a maintenance operation to be described later, a deceleration period for decelerating from a certain speed and stopping with the end of a measurement operation in one direction of rotation, an acceleration period for reaching a certain speed to start a measurement operation in the other direction of rotation from the stopped state, and an end period from the end of the last measurement operation to power-off. The deceleration period or the acceleration period is also referred to as a rotation direction switching period. It is preferable to set the deceleration period or the acceleration period as the non-measurement period since calculation such as association between a peak position in the V direction and a rotation angle becomes complicated when deceleration and acceleration occur in these periods.

### <Angle Range of Light Projecting/Receiving Module>

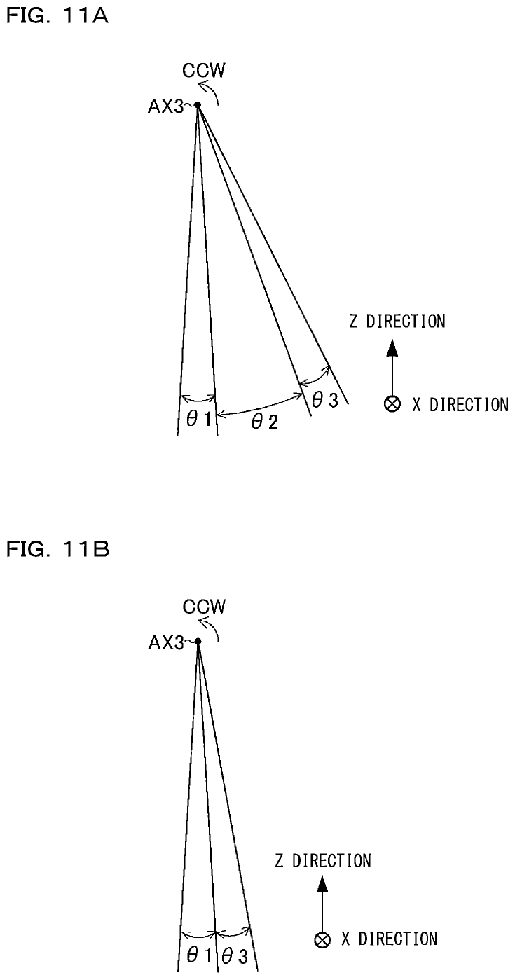

FIG. 11A is a view for describing an angle range of the light projecting/receiving module 20 in a case where the optical displacement meter 1 executes the maintenance operation. FIG. 11B is a view for describing an angle range in a case where the optical displacement meter 1 executes a rotation direction switching operation of the light projecting/receiving module 20 without executing the maintenance operation. The angle range of the light projecting/receiving module 20 includes a first angle range θ1 to be measured, a second angle range θ2 for the maintenance operation not to be measured, and a third angle range θ3 for the rotation direction switching operation not to be measured. The first angle range θ1 is determined based on a measurement range set by default or by the user. The second angle range θ2 is determined based on the first angle range θ1 and specifications of a bearing 210. The third angle range θ3 is determined based on the angular velocity of the motor 21, the moment of inertia, the specifications of the bearing 210, and the like. The control unit 22 controls the motor 21 to rotate the light projecting/receiving module 20 in the first angle range θ1 to be measured and scan the slit light L1 in the direction orthogonal to the X direction. In a case where the maintenance operation is executed, the control unit 22 controls the motor 21 such that the light projecting/receiving module 20 is rotated in the second angle range θ2 following the first angle range θ1 to execute the maintenance operation and stopped in the third angle range θ3 for the rotation direction switching operation. That is, the light projecting/receiving module 20 is configured to be rotatable up to an angle range (also referred to as a non-measurement angle range) obtained by combining the second angle range θ2 and the third angle range θ3 by the rotation of the motor 21. The rotation direction switching operation is set as the non-measurement period since it is necessary to consider deceleration and acceleration and calculation becomes complicated, and the maintenance operation is performed during the period, whereby a rotation range can be effectively utilized. In a case where the maintenance operation is not executed, the control unit 22 controls the motor 21 to rotate the light projecting/receiving module 20 in the third angle range θ3 following the first angle range θ1. In a case where the maintenance operation is not executed for each measurement operation, the rotation in the second angle range θ2 and the third angle range θ3 is not required, and thus, it is possible to reduce a takt time by switching the rotation direction in the minimum range (third angle range θ3).

According to such a configuration, even if the first angle range θ1 is small, the occurrence of fretting wear in the motor 21 can be suppressed by rotating the light projecting/receiving module 20 up to at least the second angle range θ2 for the maintenance operation. As a result, the optical displacement meter 1 can suppress an influence of the fretting wear (a decrease in life due to the fretting wear). Note that it can also be said that the optical displacement meter 1 executes the maintenance operation by rotating the light projecting/receiving module 20 in the non-measurement angle range obtained by combining the second angle range θ2 and the third angle range θ3.

Here, the first angle range θ1 to be measured means an angle range set such that image processing proceeds at least until the generation of the three-dimensional data by the three-dimensional data generation unit 28. On the other hand, the second angle range θ2 and the third angle range θ3, which are not to be measured, mean angle ranges set such that the image processing does not proceed until the generation of the three-dimensional data by the three-dimensional data generation unit 28. Therefore, in the second angle range θ2 and the third angle range θ3, which are not to be measured, the image processing may proceed until the profile generation by the profile generation unit 27, or the image processing does not necessarily proceed until the profile generation by the profile generation unit 27.

Note that, when the optical displacement meter 1 executes the measurement operation, the motor control unit 23 starts the rotation of the motor 21, the rotation of the motor 21 accelerates and then the rotation of the motor 21 becomes a constant speed, and thereafter, the rotation of the motor 21 decelerates and the rotation of the motor 21 stops. An angle range of the light projecting/receiving module 20 during a period in which the rotation of the motor 21 is at the constant speed is the first angle range θ1 to be measured. In addition, an angle range of the light projecting/receiving module 20 in the non-measurement period is at least one of the second angle range θ2 and the third angle range θ3 which are not to be measured. When the maintenance operation is executed in a period in which the measurement operation is not executed, the occurrence of failure can be suppressed without deteriorating the takt time.

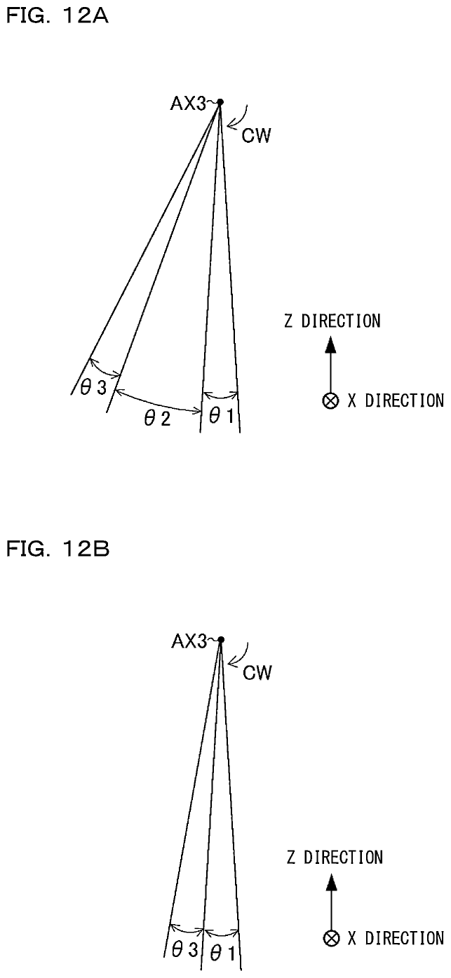

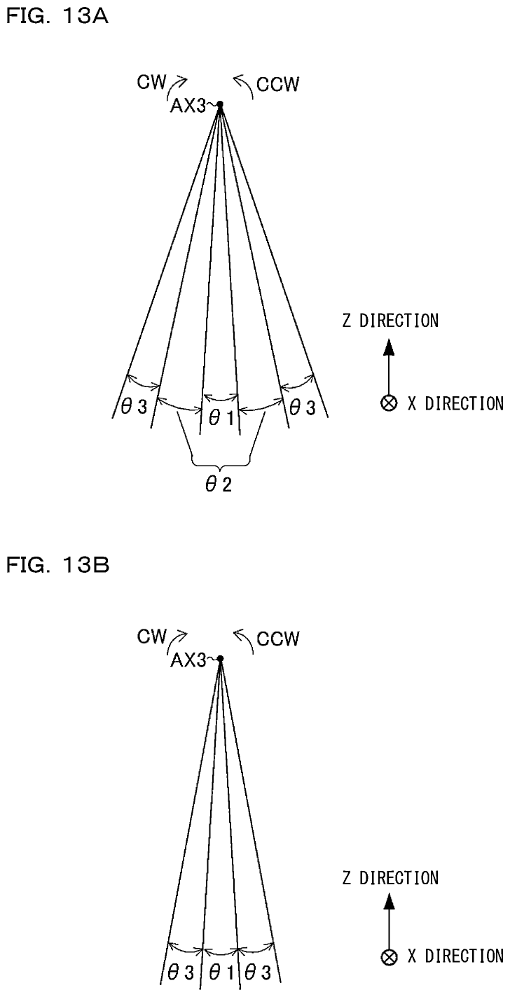

In FIGS. 11A and 11B, the second angle range θ2 and the third angle range θ3 are formed on the outer side of the first angle range θ1 toward the counterclockwise direction CCW. Note that, as illustrated in FIGS. 12A and 12B, the second angle range θ2 and the third angle range θ3 may be formed on the outer side of the first angle range θ1 toward the clockwise direction CW. In addition, as illustrated in FIGS. 13A and 13B, each of the second angle range θ2 and the third angle range θ3 may be divided into two ranges, and may be formed on both the outer side of the first angle range θ1 toward the counterclockwise direction CCW and the outer side of the first angle range θ1 toward the clockwise direction CW. In FIGS. 13A and 13B, the two ranges forming each of the second angle range θ2 and the third angle range θ3 have the same size, but may have different sizes.

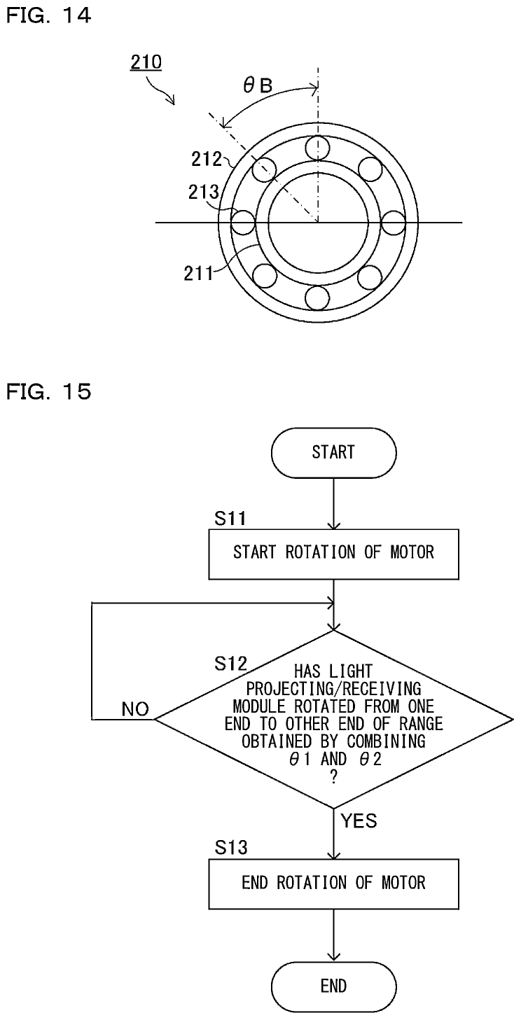

The motor 21 includes the bearing 210. The bearing 210 rotatably supports the rotor of the motor 21. In the present embodiment, it can be considered that the bearing 210 is provided on a rotation shaft of the light projecting/receiving module since the motor 21 is the direct drive system that directly rotates the light projecting/receiving module 20. In a case where an intermediate mechanism such as a speed reducer is used, the bearing is provided on both a rotation shaft of the motor and the rotation shaft of the light projecting/receiving module. FIG. 14 is a view illustrating a schematic configuration example of the bearing 210. The bearing 210 includes an inner ring 211, an outer ring 212, a plurality of rolling elements 213 disposed movably between the inner ring 211 and the outer ring 212, and a lubricant covering the plurality of rolling elements 213. As the light projecting/receiving module 20 rotates, the plurality of rolling elements 213 move between the inner ring 211 and the outer ring 212. The number and shapes of the rolling elements 213 are not limited to the example illustrated in FIG. 14. Therefore, for example, a cross roller bearing, a ball bearing, a needle bearing, or the like can be used as the bearing 210.

When the light projecting/receiving module 20 rotates in any direction of the counterclockwise direction CCW or the clockwise direction CW from one end to the other end of a range obtained by combining the first angle range θ1 and the second angle range θ2, the lubricant enters between the inner ring 211 and the rolling elements 213 and between the outer ring 212 and the rolling elements 213 due to the movement of the plurality of rolling elements 213. As a result, contact between the inner ring 211 and the rolling elements 213 and contact between the outer ring 212 and the rolling elements 213 are suppressed, and the fretting wear is suppressed. As a result, the optical displacement meter 1 can suppress an influence of the fretting wear (a decrease in life due to the fretting wear).

Preferably, the rolling elements 213 rotate by half a turn or more when the light projecting/receiving module 20 rotates in any direction of the counterclockwise direction CCW or the clockwise direction CW from one end to the other end of the range obtained by combining the first angle range θ1 and the second angle range θ2. As a result, if the lubricant exists around the rolling elements 213, the lubricant spreads over the entire circumference of the rolling elements 213 as the light projecting/receiving module 20 rotates in any direction of the counterclockwise direction CCW or the clockwise direction CW from one end to the other end of the range obtained by combining the first angle range θ1 and the second angle range θ2. Therefore, the effect of suppressing the fretting wear can be enhanced.

More preferably, the rolling elements 213 rotate by a turn or more when the light projecting/receiving module 20 rotates in any direction of the counterclockwise direction CCW or the clockwise direction CW from one end to the other end of the range obtained by combining the first angle range θ1 and the second angle range θ2. As a result, if the lubricant exists around the rolling elements 213, the lubricant spreads over the entire circumference of the rolling elements 213 as the light projecting/receiving module 20 rotates in any direction of the counterclockwise direction CCW or the clockwise direction CW from one end to the other end of the range obtained by combining the first angle range θ1 and the second angle range θ2. Therefore, the effect of suppressing the fretting wear can be further enhanced.

In addition, preferably, the first angle range θ1 is smaller than an angle θB between two adjacent rolling elements 213, and the range obtained by combining the first angle range θ1 and the second angle range θ2 is set to be equal to or larger than the angle between the two adjacent rolling elements 213. As a result, when the light projecting/receiving module 20 rotates in any direction of the counterclockwise direction CCW or the clockwise direction CW from one end to the other end of the range obtained by combining the first angle range θ1 and the second angle range θ2, the rolling element 213 moves to at least a position of the adjacent rolling element 213. As a result, films of the lubricant are formed on a track surface of the inner ring 211 on which the rolling elements 213 roll and a track surface of the outer ring 212 on which the rolling elements 213 roll, and the films of the lubricant are formed on the entire outer circumference of the inner ring 211 and the entire inner circumference of the outer ring 212. Therefore, the effect of suppressing the fretting wear can be enhanced.

Further, preferably, the plurality of rolling elements 213 pass through adjacent accumulating portions while rotating when the accumulating portions of the lubricant are formed between two adjacent rolling elements 213 and the light projecting/receiving module 20 rotates in any direction of the counterclockwise direction CCW or the clockwise direction CW from one end to the other end of the range obtained by combining the first angle range θ1 and the second angle range θ2. As a result, the films of the lubricant are reliably formed on the track surface of the inner ring 211 on which the rolling elements 213 roll and the track surface of the outer ring 212 on which the rolling elements 213 roll. Therefore, the effect of suppressing the fretting wear can be further enhanced.

### <Processing Flow (Maintenance Operation)>

FIG. 15 is a view illustrating a processing flow of the maintenance operation of the optical displacement measurement system 100. When the optical displacement measurement system 100 executes the maintenance operation, the optical displacement meter 1 executes a maintenance operation.

For example, the processing flow of FIG. 15 may be started every time the processing flow of FIG. 10 ends. In this case, the optical displacement meter 1 executes the maintenance operation every time the measurement operation is executed. For example, the motor control unit 23 causes the light projecting/receiving module 20 to be rotated in the clockwise direction CW in the first angle range θ1 to execute the measurement operation, thereafter, to be further rotated in the clockwise direction CW in the second angle range θ2 to execute the maintenance operation, and to be decelerated in the third angle range θ3 and stopped. The motor control unit 23 causes the light projecting/receiving module 20 to be rotated in the counterclockwise direction CCW using a part of the third angle range θ3 and the second angle range θ2 and to be stopped at a predetermined position in order for acceleration to a rotation speed required for the measurement operation of the first angle range θ1 in the counterclockwise direction CCW. Thereafter, when a trigger (instruction) for starting the next measurement operation is received, the motor control unit 23 causes the light projecting/receiving module 20 to be accelerated and rotated in the counterclockwise direction CCW to execute the next measurement operation at a certain rotation speed, thereafter, to be further rotated in the counterclockwise direction CCW in the second angle range θ2 to execute the maintenance operation, and to be decelerated in the third angle range θ3 and stopped. By repeating the above operations, the maintenance operation can be executed during replacement of the workpiece W between the measurement operation and the measurement operation, and thus, the maintenance operation can be executed efficiently in terms of time.

In addition, for example, the processing flow of FIG. 15 may be started at the time of activation (more specifically, immediately after activation) of the optical displacement meter 1. That is, in the activation period described above, the control unit 22 causes the light projecting/receiving module 20 to be rotated at least in the second angle range θ2 to execute the maintenance operation and then to be rotated to a start position of the first measurement operation. In this case, the optical displacement meter 1 executes the maintenance operation when the optical displacement meter 1 is activated.

In addition, for example, the processing flow of FIG. 15 may be started at the end (more specifically, immediately before the end) of the optical displacement meter 1. That is, in the end period described above, the control unit 22 executes the maintenance operation by rotating the light projecting/receiving module 20 at least in the second angle range θ2, and thereafter, turns off a power supply. In this case, the optical displacement meter 1 executes the maintenance operation at the end of the optical displacement meter 1. The occurrence of failure can be efficiently suppressed by executing the maintenance operation at the time of activation or end which hardly affects the takt time.

In addition, for example, the processing flow of FIG. 15 may be started every time the measurement operation is executed a designated number of times. In this case, the optical displacement meter 1 executes the maintenance operation every time the measurement operation is executed the designated number of times. A value of the designated number of times is stored in, for example, the optical displacement meter 1 or a memory built in the control device 2. Preferably, the value of the designated number of times is changeable by a user input received by the input device 4.

In addition, for example, the processing flow of FIG. 15 may be started every time a designated time elapses. In this case, the optical displacement meter 1 executes the maintenance operation every time the designated time elapses. A value of the designated time is stored in, for example, the optical displacement meter 1 or the memory built in the control device 2. Preferably, the value of the designated time is changeable by a user input received by the input device 4.

In addition, for example, the processing flow of FIG. 15 may be started by a user input instructing the execution of the maintenance operation. In this case, the optical displacement meter 1 executes the maintenance operation by the user input instructing the execution of the maintenance operation. The optical displacement meter 1 may provide the control device 2 with information based on an elapsed time from the most recent execution of the maintenance operation, and the control device 2 may cause the display device 3 to perform display based on the information. As a result, it is possible to present the information that is useful as a reference to the user who examines whether or not to instruct the execution of the maintenance operation. The information may be, for example, the elapsed time itself from the most recent execution of the maintenance operation, or may be a flag or a message for prompting the maintenance operation that is generated when the elapsed time from the most recent execution of the maintenance operation is equal to or more than a certain time. In addition, the optical displacement meter 1 may receive an instruction for executing a maintenance operation from the user, count the number of times of switching in the rotation direction of the light projecting/receiving module 20 by the measurement operation after the maintenance operation, and stop execution of a measurement operation until receiving an instruction for executing a new maintenance operation when the number of times of switching reaches a predetermined number of times. As a result, the measurement operation is stopped until the maintenance operation is executed, and thus, the occurrence of fretting wear can be suppressed. For example, the motor control unit 23 counts the number of times of switching, and the communication unit 25 receives the instruction for executing the maintenance operation from the user.

First, in step S11, the motor control unit 23 starts the rotation of the motor 21.

In subsequent step S12, the motor control unit 23 determines whether or not the light projecting/receiving module 20 has rotated from one end to the other end of the range obtained by combining the first angle range θ1 and the second angle range θ2. In a case where the light projecting/receiving module 20 has not rotated from one end to the other end of the range obtained by combining the first angle range θ1 and the second angle range θ2, the determination process of step S12 is continued, and the rotation of the motor 21 is continued.

When the light projecting/receiving module 20 has rotated from one end to the other end of the range obtained by combining the first angle range θ1 and the second angle range θ2, the flow proceeds to step S13.

In step S13, the motor control unit 23 ends the rotation of the motor 21.

When the process of step S13 ends, the processing flow of FIG. 15 ends.

In the maintenance operation, measurement of a shape of the workpiece W is unnecessary, and thus, it is not necessary to determine the rotation speed in consideration of an exposure time and the like in the imaging unit 13. Therefore, the rotation speed of the light projecting/receiving module 20 in the maintenance operation may be faster than the rotation speed of the light projecting/receiving module in the measurement operation. Accordingly, the time required for the maintenance operation can be shortened.

Note that, in a case where the light projecting/receiving module 20 in the maintenance operation does not rotate at a constant speed, a maximum rotation speed of the light projecting/receiving module 20 in the maintenance operation may be regarded as the rotation speed of the light projecting/receiving module 20 in the maintenance operation as a comparison target of the rotation speed of the light projecting/receiving module 20 in the measurement operation. For example, when shifting to the maintenance operation after the measurement operation, the control unit 22 can also start the maintenance operation by causing acceleration from a certain rotation speed in the measurement operation. Similarly, in a case where the light projecting/receiving module 20 in the measurement operation does not rotate at a constant speed, a maximum rotation speed of the light projecting/receiving module 20 in the measurement operation may be regarded as the rotation speed of the light projecting/receiving module 20 in the measurement operation as a comparison target of the rotation speed of the light projecting/receiving module 20 in the maintenance operation. In addition, in the maintenance operation, the measurement operation (the operation in which the image processing proceeds at least until the generation of the three-dimensional data by the three-dimensional data generation unit 28) may be executed while the light projecting/receiving module 20 rotates in the first angle range θ1.

In the above description, the first angle range θ1 for the measurement operation, the second angle range θ2 for the maintenance operation, and the third angle range θ3 for the rotation direction switching have been distinguished and described, but the invention is not limited to one explicitly including the second angle range θ2 for the maintenance operation. For example, if the light projecting/receiving module 20 rotates from one end to the other end of an angle range obtained by combining the first angle range θ1 for the measurement operation and the third angle range θ3 for the rotation direction switching operation, the maintenance operation is substantially executed together when the lubricant enters between the inner ring and the rolling elements and between the outer ring and the rolling elements due to the movement of the plurality of rolling elements of the bearing 210, and thus, the fretting wear can be suppressed. Note that, in a case where the measurement operation is executed also in the rotation direction switching operation (the deceleration period and the acceleration period), there is substantially no distinction between the first angle range θ1 and the third angle range θ3, and the third angle range θ3 is included in the first angle range θ1. Therefore, if the light projecting/receiving module 20 rotates from one end to the other end of the first angle range θ1 for the measurement operation, the maintenance operation is substantially executed together even when the lubricant enters between the inner ring and the rolling elements and between the outer ring and the rolling elements due to the movement of the plurality of rolling elements of the bearing 210, and thus, the fretting wear can be suppressed.

### CONCLUSION

Hereinafter, various embodiments described above will be comprehensively described.

For example, a first optical displacement meter disclosed in the present specification has a configuration (first configuration) in which a light projecting/receiving module including a light projecting unit that emits slit light extending in an X direction, a light receiving lens that collects reflected light from a workpiece, and an imaging unit that receives light collected by the light receiving lens, a motor integrally rotating the light projecting/receiving module, a bearing supporting a rotation shaft of the light projecting/receiving module, and a control unit controlling the motor to rotate the light projecting/receiving module in a first angle range to be measured to scan the slit light in a direction orthogonal to the X direction are included, and the bearing is rotated together with the light projecting/receiving module by the motor to a second angle range not to be measured on the outer side of the first angle range.

The optical displacement meter having the first configuration may adopt a configuration (second configuration) in which the bearing includes an inner ring, an outer ring, a plurality of rolling elements disposed movably between the inner ring and the outer ring, and a lubricant covering the plurality of rolling elements, the plurality of rolling elements move between the inner ring and the outer ring as the light projecting/receiving module rotates, and the lubricant enters between the inner ring and the rolling elements and between the outer ring and the rolling elements due to the movement of the plurality of rolling elements when the light projecting/receiving module rotates from one end to the other end of a range obtained by combining the first angle range and the second angle range.

The optical displacement meter having the second configuration may adopt a configuration (third configuration) in which the rolling elements may rotate by half a turn or more when the light projecting/receiving module rotates from the one end to the other end of the range obtained by combining the first angle range and the second angle range.

The optical displacement meter having the second or third configuration may have a configuration (fourth configuration) in which the first angle range is smaller than an angle between two of the rolling elements adjacent to each other, and the range obtained by combining the first angle range and the second angle range is set to be equal to or larger than the angle between the two of the rolling elements adjacent to each other.

The optical displacement meter having any one of the second to fourth configurations may adopt a configuration (fifth configuration) in which an accumulating portion of the lubricant is formed between two of the rolling elements adjacent to each other, and each of the plurality of rolling elements passes through the accumulating portion that is adjacent while rotating when the light projecting/receiving module rotates from the one end to the other end of the range obtained by combining the first angle range and the second angle range.

The optical displacement meter having any one of the first to fifth configurations may adopt a configuration (sixth configuration) in which the optical displacement meter is configured to be capable of executing a measurement operation and a maintenance operation, and the control unit controls the motor to rotate the light projecting/receiving module in the first angle range in the measurement operation, and controls the motor to rotate the light projecting/receiving module at least in the second angle range in the maintenance operation.

The optical displacement meter having the sixth configuration may adopt a configuration (seventh configuration) in which the optical displacement meter has a measurement period in which the light projecting/receiving module is rotated in a first rotation direction or a second rotation direction opposite to the first rotation direction to execute the measurement operation, and a non-measurement period in which the measurement operation is not executed, and the control unit rotates the light projecting/receiving module at least in the second angle range to execute the maintenance operation in the non-measurement period.

The optical displacement meter having the seventh configuration may adopt a configuration (eighth configuration) in which the non-measurement period includes an activation period from when a power supply of the optical displacement meter is turned on to when a first measurement operation starts, or an end period from when a last measurement operation ends to when the power supply of the optical displacement meter is turned off, and the control unit rotates the light projecting/receiving module at least in the second angle range to execute the maintenance operation, and thereafter, rotates the light projecting/receiving module to a start position of the first measurement operation in the activation period, or rotates the light projecting/receiving module at least in the second angle range to execute the maintenance operation, and thereafter, turns off the power supply in the end period.

the optical displacement meter having the seventh or eighth configuration may adopt a configuration (ninth configuration) in which the control unit rotates the light projecting/receiving module at a substantially constant speed in the first rotation direction or the second rotation direction to execute the measurement operation in the measurement period, and rotates the light projecting/receiving module in the second angle range to execute the maintenance operation, and stops the light projecting/receiving module in a third angle range for an operation of switching a rotation direction of the light projecting/receiving module in the non-measurement period.

The optical displacement meter having any one of the seventh to ninth configurations may adopt a configuration (tenth configuration) in which the control unit rotates the light projecting/receiving module in the second angle range at a speed higher than that in the measurement operation to execute the maintenance operation.

The optical displacement meter having the ninth configuration may adopt a configuration (eleventh configuration) in which, in the non-measurement period, the control unit selectively executes a first mode in which the light projecting/receiving module is rotated in the second angle range and the third angle range to execute the maintenance operation and switching of the rotation direction of the light projecting/receiving module, and a second mode in which the light projecting/receiving module is rotated in the third angle range to execute the switching of the rotation direction without executing the maintenance operation.

The optical displacement meter having the seventh to eleventh configurations may adopt a configuration (twelfth configuration) in which the optical displacement meter receives an instruction for executing the maintenance operation from a user, counts the number of times of switching of a rotation direction of the light projecting/receiving module by the measurement operation after the maintenance operation, and stops execution of the measurement operation until an instruction for executing a new maintenance operation is received when the number of times of switching reaches a predetermined number of times.

For example, a second optical displacement meter disclosed in the present specification has a configuration (thirteenth configuration) in which a light projecting/receiving module including a light projecting unit that emits slit light extending in an X direction, a light receiving lens that collects reflected light from a workpiece, and an imaging unit that receives light collected by the light receiving lens, a motor that integrally rotates the light projecting/receiving module, a bearing that support a rotation shaft of the light projecting/receiving module, and a control unit that controls the motor to rotate the light projecting/receiving module in a first angle range to be measured to scan the slit light in a direction orthogonal to the X direction are included, the bearing includes an inner ring, an outer ring, a plurality of rolling elements disposed movably between the inner ring and the outer ring, and a lubricant covering the plurality of rolling elements, the plurality of rolling elements move between the inner ring and the outer ring as the light projecting/receiving module rotates, and the lubricant enters between the inner ring and the rolling elements and between the outer ring and the rolling elements due to the movement of the plurality of rolling elements when the light projecting/receiving module rotates from one end to the other end of the first angle range.

The optical displacement meter having the thirteenth configuration may adopt a configuration (fourteenth configuration) in which the rolling elements rotate by half a turn or more when the light projecting/receiving module rotates from the one end to the other end of the first angle range.

The optical displacement meter having the thirteenth or fourteenth configuration may adopt a configuration (fifteenth configuration) in which the first angle range is set to be equal to or larger than an angle between two of the rolling elements adjacent to each other.

The optical displacement meter having any one of the thirteenth to fifteenth configurations may adopt a configuration (sixteenth configuration) in which an accumulating portion of the lubricant is formed between two of the rolling elements adjacent to each other, and each of the plurality of rolling elements passes through the accumulating portion that is adjacent while rotating when the light projecting/receiving module rotates from the one end to the other end of the first angle range.

### Other Modifications

Note that, in addition to the above-described embodiments, various alterations can be applied to various technical features disclosed in the present specification within a scope not departing from the spirit of the technical creation. That is, it is to be understood that the above-described embodiments are illustrative in all respects and not restrictive, and the technical scope of the invention is defined by the claims, and includes all alterations falling within the meaning and scope equivalent to the claims.

What is claimed is:

1. An optical displacement meter comprising:
a light projecting/receiving module including a light projecting unit that emits slit light extending in an X direction, a light receiving lens that collects reflected light from a workpiece, and an imaging unit that receives light collected by the light receiving lens;
a motor that integrally rotates the light projecting/receiving module;
a bearing that supports a rotation shaft of the light projecting/receiving module; and
a control unit that controls the motor to rotate the light projecting/receiving module in a first angle range to be measured to scan the slit light in a direction orthogonal to the X direction,
wherein the bearing is rotated together with the light projecting/receiving module by the motor to a second angle range not to be measured on an outer side of the first angle range.

2. The optical displacement meter according to claim 1, wherein
the bearing includes an inner ring, an outer ring, a plurality of rolling elements disposed movably between the inner ring and the outer ring, and a lubricant covering the plurality of rolling elements,
the plurality of rolling elements move between the inner ring and the outer ring as the light projecting/receiving module rotates, and
the lubricant enters between the inner ring and the rolling elements and between the outer ring and the rolling elements due to the movement of the plurality of rolling elements when the light projecting/receiving module rotates from one end to another end of a range obtained by combining the first angle range and the second angle range.

3. The optical displacement meter according to claim 2, wherein the rolling elements rotate by half a turn or more when the light projecting/receiving module rotates from the one end to the another end of the range obtained by combining the first angle range and the second angle range.

4. The optical displacement meter according to claim 2, wherein the first angle range is smaller than an angle between two of the rolling elements adjacent to each other, and the range obtained by combining the first angle range and the second angle range is set to be equal to or larger than the angle between the two of the rolling elements adjacent to each other.

5. The optical displacement meter according to claim 2, wherein an accumulating portion of the lubricant is formed between two of the rolling elements adjacent to each other, and each of the plurality of rolling elements passes through the accumulating portion that is adjacent while rotating when the light projecting/receiving module rotates from the one end to the another end of the range obtained by combining the first angle range and the second angle range.

6. The optical displacement meter according to claim 1, the optical displacement meter being configured to be capable of executing a measurement operation and a maintenance operation,
wherein the control unit
controls the motor to rotate the light projecting/receiving module in the first angle range in the measurement operation, and
controls the motor to rotate the light projecting/receiving module at least in the second angle range in the maintenance operation.

7. The optical displacement meter according to claim 6, the optical displacement meter having
a measurement period in which the light projecting/receiving module is rotated in a first rotation direction or a second rotation direction opposite to the first rotation direction to execute the measurement operation, and
a non-measurement period in which the measurement operation is not executed,
wherein the control unit rotates the light projecting/receiving module at least in the second angle range to execute the maintenance operation in the non-measurement period.

8. The optical displacement meter according to claim 7, wherein
the non-measurement period includes an activation period from when a power supply of the optical displacement meter is turned on to when a first measurement operation starts, or an end period from when a last measurement operation ends to when the power supply of the optical displacement meter is turned off, and
the control unit
rotates the light projecting/receiving module at least in the second angle range to execute the maintenance operation, and thereafter, rotates the light projecting/receiving module to a start position of the first measurement operation in the activation period, or
rotates the light projecting/receiving module at least in the second angle range to execute the maintenance operation, and thereafter, turns off the power supply in the end period.

9. The optical displacement meter according to claim 7, wherein
the control unit
rotates the light projecting/receiving module at a substantially constant speed in the first rotation direction or the second rotation direction to execute the measurement operation in the measurement period, and
rotates the light projecting/receiving module in the second angle range to execute the maintenance operation, and stops the light projecting/receiving module in a third angle range for an operation of switching a rotation direction of the light projecting/receiving module in the non-measurement period.

10. The optical displacement meter according to claim 9, wherein the control unit rotates the light projecting/receiving module in the second angle range at a speed higher than a speed in the measurement operation to execute the maintenance operation.

11. The optical displacement meter according to claim 9, wherein
in the non-measurement period, the control unit selectively executes
a first mode in which the light projecting/receiving module is rotated in the second angle range and the third angle range to execute the maintenance operation and switching of the rotation direction of the light projecting/receiving module, and
a second mode in which the light projecting/receiving module is rotated in the third angle range to execute the switching of the rotation direction without executing the maintenance operation.

12. The optical displacement meter according to claim 7, the optical displacement meter
receiving an instruction for executing the maintenance operation from a user, and counting a number of times of switching of a rotation direction of the light projecting/receiving module by the measurement operation after the maintenance operation, and
stopping execution of the measurement operation until an instruction for executing a new maintenance operation is received when the number of times of switching reaches a predetermined number of times.

13. An optical displacement meter comprising:
a light projecting/receiving module including a light projecting unit that emits slit light extending in an X direction, a light receiving lens that collects reflected light from a workpiece, and an imaging unit that receives light collected by the light receiving lens;
a motor that integrally rotates the light projecting/receiving module;
a bearing that support a rotation shaft of the light projecting/receiving module; and
a control unit that controls the motor to rotate the light projecting/receiving module in a first angle range to be measured to scan the slit light in a direction orthogonal to the X direction,
wherein the bearing includes an inner ring, an outer ring, a plurality of rolling elements disposed movably between the inner ring and the outer ring, and a lubricant covering the plurality of rolling elements,
the plurality of rolling elements move between the inner ring and the outer ring as the light projecting/receiving module rotates, and
the lubricant enters between the inner ring and the rolling elements and between the outer ring and the rolling elements due to the movement of the plurality of rolling elements when the light projecting/receiving module rotates from one end to another end of the first angle range.

14. The optical displacement meter according to claim 13, wherein the rolling elements rotate by half a turn or more when the light projecting/receiving module rotates from the one end to the another end of the first angle range.

15. The optical displacement meter according to claim 13, wherein the first angle range is set to be equal to or larger than an angle between two of the rolling elements adjacent to each other.

16. The optical displacement meter according to claim 13, wherein an accumulating portion of the lubricant is formed between two of the rolling elements adjacent to each other, and each of the plurality of rolling elements passes through the accumulating portion that is adjacent while rotating when the light projecting/receiving module rotates from the one end to the another end of the first angle range.
